(19) United States
(12) Patent Application Publication
(10) Pub. No.: US 2016/0356086 A1
(43) Pub. Date: Dec. 8, 2016

(54) ELECTRONIC COMPONENT FOR A STEP LADDER

(71) Applicant: Asia Connection LLC, New York, NY (US)

(72) Inventors: Mitch Saccoccio, Clarksville, VA (US); Jonathan Bonelli, New York, NY (US)

(21) Appl. No.: 15/175,616

(22) Filed: Jun. 7, 2016

Related U.S. Application Data
(60) Provisional application No. 62/172,507, filed on Jun. 8, 2015.

(51) Int. Cl. E06C 7/18; F21V 31/00; F21V 33/00; F21V 23/04; E06C 7/00; E06C 1/14

(52) U.S. Cl. CPC E06C 7/183; E06C 7/00; E06C 1/14; F21V 33/006; F21V 23/0464; F21V 31/005

(57) ABSTRACT

A step ladder that is assembled with removably attachable components and an electronic component in one or more of the removably attachable components is disclosed herein. The removably attachable components of the step ladder include one ore risers, steps, railings and side panels. As one example, a riser may include a light fixture therein that is connected to a controller and a power source. The controller is configured to control aspects of the light fixture, including when to turn tie light fixture on and off. A photoelectric sensor that detects light may also be implemented, which, in communication with the controller, turns on and off the light fixture based on whether or not light is detected. Other components of the step ladder may also include electronic components, including a light fixture, radio, speaker, blue tooth other wireless capabilities, etc.

### CROSS REFERENCE TO RELATED APPLICATION(S)

This application claims the benefit of U.S. Provisional Application No. 62/172,507, filed Jun. 8, 2015, the entire disclosure of which is hereby incorporated herein by reference.

### BACKGROUND

The present disclosure generally relates to light assemblies for a pool, in particular a pre-assembled light riser for a step ladder.

Swimming pools utilize a ladder or steps for a person to enter and exit the water within the pool. At certain times, such as at night, a person may want an electronic component, such as a light, near the pool so everyone can adequately see their surroundings. Some people may use a separate outside light (e.g., a flashlight or floodlight), others may light tiki torches, and yet others may purchase lights specifically designed to be installed in or near the pool. Lights designed to be assembled in or near the pool, such as on the pool ladder or steps, may be difficult or perhaps dangerous for a person to assemble and install.

### SUMMARY

A light fixture installed on a riser of step ladder for a pool is disclosed herein. The step ladder may include risers, steps, a railing, and a side panel. The riser with the light fixture may have been pre-installed into one or more of the risers on the step ladder, or the riser with the light fixture may be a separate component that replaces a removably attached riser on the step ladder. The riser may define a hole thereon, where the light fixture is positioned and secured into using a fastening mechanism. The light fixture of the riser may be electrically connected to a controller, and the controller may be connected to a power source. The controller is configured to control various aspects associated with the light fixture, including when the light fixture is turned on and off. In addition, a sensor, such as a photoelectric sensor, may be implemented, which is configured to detect the presence of sunlight. In this regard, when sunlight is detected the photoelectric sensor sends a signal to the controller to turn off the light fixture. Conversely, when sunlight is not detected then the photoelectric sensor sends a signal to the controller to turn the light fixture.

In addition, multiple components of the step ladder may include light fixtures or other electronic components. For example, a second riser may contain an additional light fixture to provide even more light. As a further example, the side panel, step or railing may include the light fixture. Furthermore, other electrical components may be installed on the various components of the light fixture, such as a radio or speakers, that are also electrically connected to the controller and power source.

As one embodiment, a riser for steps is disclosed herein, the riser including a planar surface defining a hole therein; and a light fixture positioned and secured within the hole, wherein the riser is removably attachable to the steps.

As another embodiment, a step ladder is disclosed herein, the step ladder including a step; a riser removably attached to the step, wherein at least one of the step or the riser includes a pre-assembled electronic component.

### BRIEF DESCRIPTION OF THE DRAWINGS

Various embodiments are described below with reference to the drawings, wherein:

FIG. 1 is a perspective view of a step ladder in accordance with aspects of the present disclosure;

FIGS. 2A-D depict assembly of the step ladder in accordance with aspects of the present disclosure;

FIGS. 3A-B illustrate a controller and wire in accordance with aspects of the present disclosure;

FIGS. 4A-8 illustrate the controller and a detailed view of the connection between the controller, light fixture and power source in accordance with aspects of the present disclosure;

FIG. 5 illustrates various connections between electronic components of the step ladder, the controller, and a computing device in accordance with aspects of the present disclosure;

FIG. 6A-D are various views of the step ladder in accordance with aspects of the present disclosure; and

FIGS. 7A-E are views of a riser with a light fixture in accordance with aspects of the present disclosure.

### DETAILED DESCRIPTION OF PREFERRED EMBODIMENT(S)

The present disclosure may be understood more readily by reference to the following detailed description of the disclosure taken in connection with the accompanying figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure.

Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

Reference will now be made in detail to the exemplary embodiments of the present disclosure, which are illustrated in the accompanying drawings.

The step ladder described herein includes a light fixture installed within a riser of the step ladder. The step ladder may include steps, risers, railings, and a side panel. The light fixture of the riser may either come pre-assembled within the packaging of the original step ladder, or the riser with the light fixture may be purchased separately and then installed onto the step ladder. For example, the pre-assembled light riser includes grooves or other connecting mechanisms so that when removing a previous riser on the pool steps, the pre-assembled light riser can easily fit into the place of the previous riser. The connecting mechanisms may be male-female mate components, grooves that tit into a corresponding tongue, press-fit mechanisms, etc. A low voltage wire may connect to the pre-assembled light riser, which connects to a controller, and the controller in turn is connected to a power source to provide power/voltage to the controller and the pre-assembled light riser.

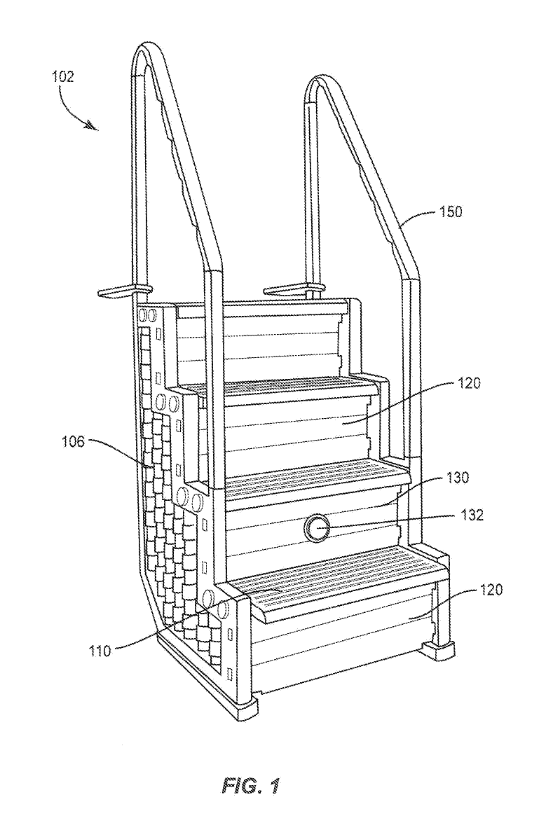

FIG. 1 is an example of step ladder 102 described above, which can include steps 110, risers 120, side panels 106 and railings 150. In addition, step ladder 102 includes pre-assembled light riser 130 which includes light fixture 132 secured within the riser itself. It should be understood that although step ladder 102 depicts a certain amount of steps, risers, side panels, and railings, the present disclosure is not limited thereto, but rather any number of steps, risers, railings, and side panels may be implemented, including only one, two, etc. In addition, although step ladder 102 depicts only one pre-assembled light riser 130, it should be understood that any number of pre-assembled light risers 130 may be implemented, such as every riser may include light fixture 132.

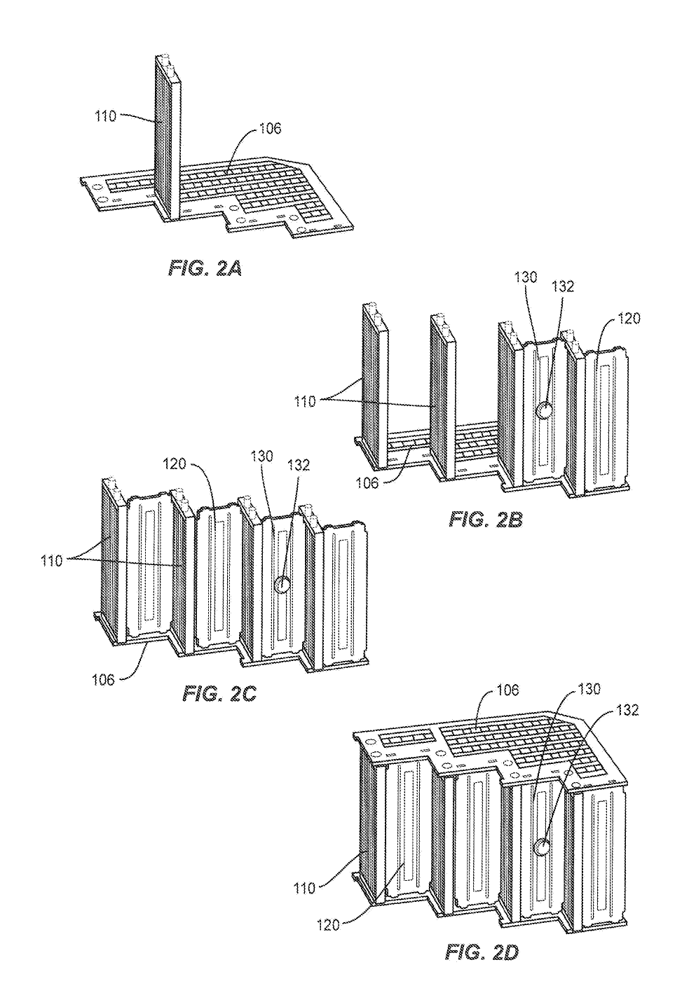

FIGS. 2A-D illustrate the various steps in assembling step ladder 102, each of the components of which are removably attachable and thereby replaceable. For example, as shown in FIG. 2A step 110 is removably attached to side panel 106 via a connecting mechanism. Although the connecting mechanism shown implements a press-fit mechanism, in which a male member is inserted into a female member, other connecting mechanisms are possible as well. For instance, friction fit, tab and notch, screw and bolt, etc.

FIGS. 2B-C illustrate risers 120 being installed along with additional steps 110 being installed as well. FIGS. 2B-D depict protruding tabs from risers 120 that are ultimately received within openings or cut-outs of both side panels 106. In addition, risers 120 may be installed on step ladder 102 similarly as steps 110, such as being removably attached to both side panels 106 using press-fit, friction fit, tab and notch, screw and bolt, etc. In addition, risers 120 may include grooves that slide into corresponding grooves on steps 110 to better secure risers 120 thereto. In this regard, the grooves of risers 120 may be on one or both of the ends that connect with steps 110, and the corresponding grooves on steps 110 may similarly be on one or both sides of steps 110. It should be understood, however, that risers 120 may be removably attached to steps 110 using a connecting mechanism (e.g., press-fit, friction fit, tab and notch, screws and bolts, etc.) in addition to or distinct from being removably attached to side panel 106.

Pre-assembled light riser 130 may connect to side panel 106 similarly as the other risers 120 described above. Although FIGS. 2B-C depict pre-assembled light riser 130 being positioned at the second riser location, pre-assembled light riser 130 may be positioned and removably attached to any of the risers positioned on step ladder 102. FIG. 2B illustrates a second side panel 106 attaching to risers 120 and steps 110.

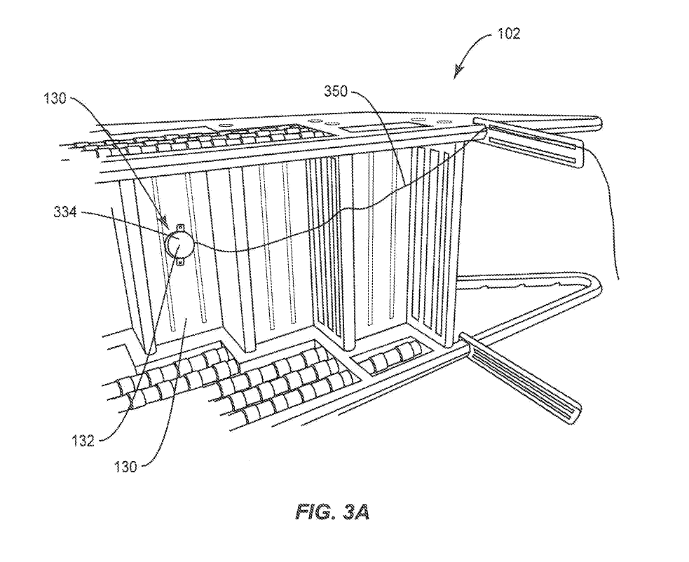

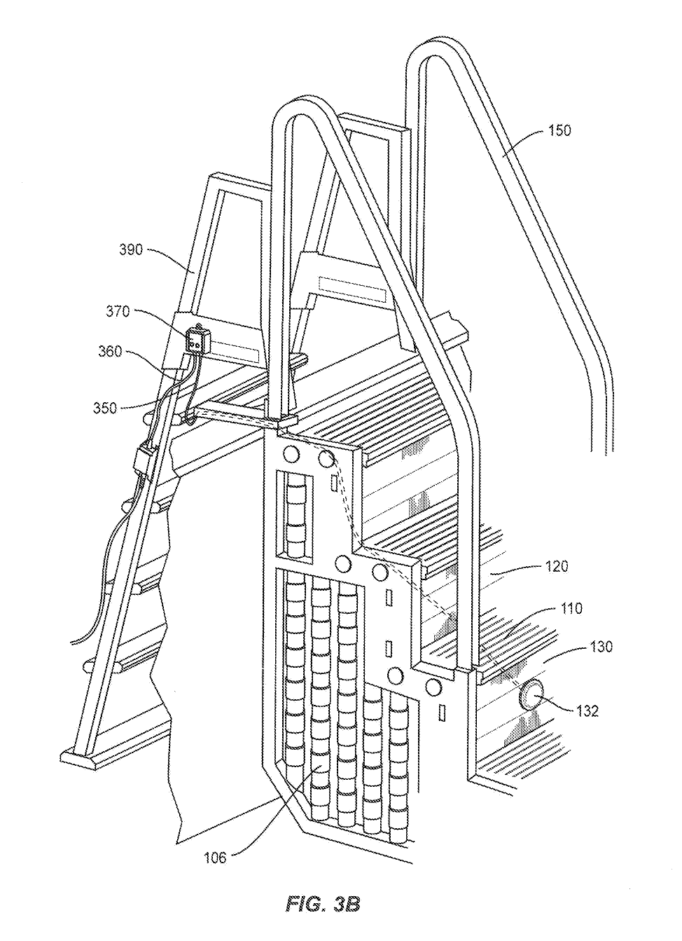

Pre-assembled light riser 130 includes a cut-out or opening thereon where light fixture 132 is positioned and secured. Light fixture 132 may be any light including an LED, filament, etc. Light fixture 132 may be sealed and waterproof so that it cannot be damaged by water or other harmful particles. For example, light fixture 132 may be partially or fully encapsulated by another layer, such as glass, plastic, etc., so that water or any liquid and debris cannot damage the electrical associated with light fixture 132. For example. FIG. 3A depicts a view underneath step ladder 102, which illustrates casing 334 which encases light fixture 132. Casing 334 encases and encapsulates light fixture 130 so that liquids and debris cannot interfere with or damage the components of light fixture 130, thereby causing a short circuit or other damage. As an alternative, pre-assembled light riser 130 may not include a cut-out or opening, and rather light fixture 132 may be attached directly to a surface of the riser itself.

FIGS. 3A-B illustrate the connection between light fixture 130 and controller 370. For example, as shown in FIG. 3A light fixture 130 is connected to wire 350. From here and referring to FIG. 3B, wire 350 extends underneath step ladder 102 and connects to controller 370. In addition, controller 370 is also connected to power wire 360 which extends to a power source (not shown), the power source of which thereby provides voltage or power to controller 370 and light fixture 130. Although FIG. 3B illustrates controller positioned on a side of step ladder 102. It should be understood that controller 370 can be positioned at any location of step ladder 102, and the wire 350 and power wire 360 are similarly adjustable.

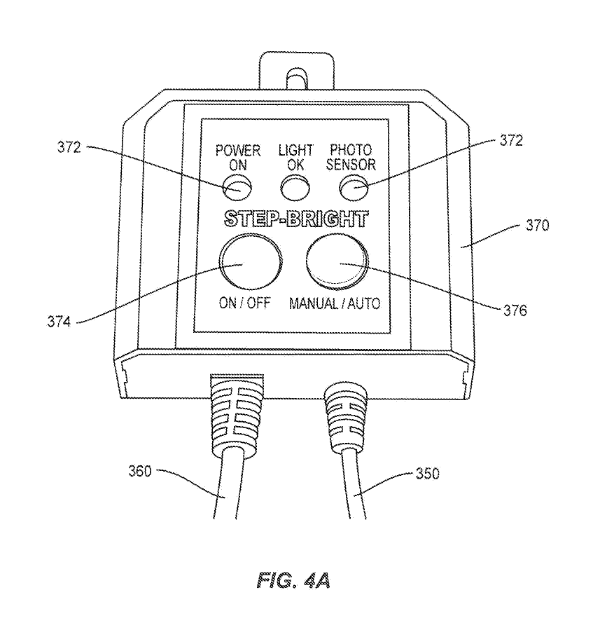

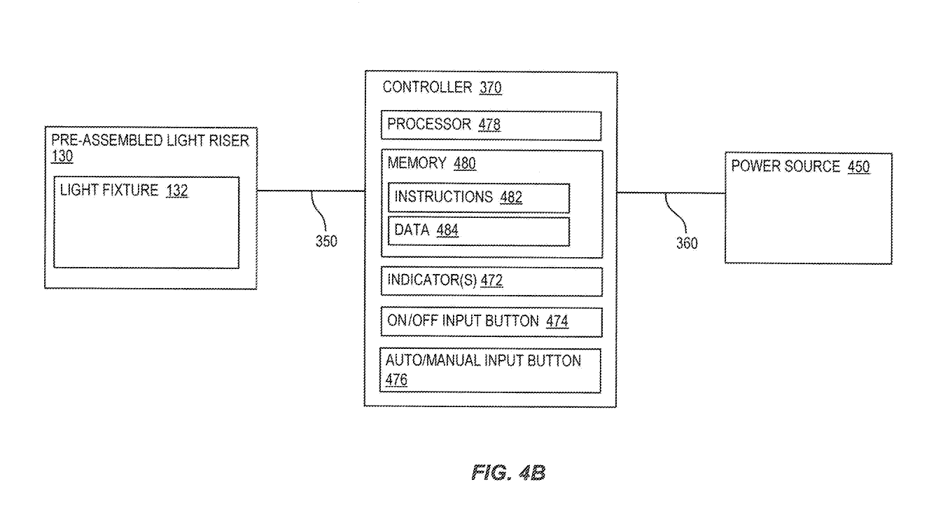

FIGS. 4A-B illustrate a perspective view of controller 370 and a detailed schematic view of the connection between pre-assembled light riser 130, controller 370, and power source 450. For example, controller 370 includes indicators 472, on/off input button 474 and manual/auto input button 476. Controller 370 can include the depicted indicators and input mechanisms as a means for a user to control the operation of light fixture 132. In this regard and as shown in FIG. 4B. controller 370 can also include processor 478 and memory 480, which contains instructions 482 and data 484. Power source 450 provides voltage such as alternating current (AC) or direct current (DC) to controller 370 and riser 130 via wire 350 and power wire 360. As an alternative, power source 450 may be directly connected to both light fixture 132 and controller 370. Furthermore, power source 450 may any one or more of an outlet, battery, rechargeable battery, solar panel, etc. which provides electrical energy to the components of the step ladder.

Memory 480 can be of any non-transitory type capable of storing information accessible by processor 478, such as a hard-drive, memory card, Read Only Memory (“ROM”), Random Access Memory (“RAM”), Digital Versatile Disc (“DVD”), Compact Disc Read Only Memory (“CD-ROM”), write-capable, and read-only memories.

Instructions 482 can be any set of instructions to be executed directly, such as machine code, or indirectly, such as scripts, by processor 478. In that regard, the terms “instructions,” “application,” “steps” and “programs” can be used interchangeably herein. Instructions 482 can be stored in object code format for direct processing by processor 478, or in any other computing device language including scripts or collections of independent source code modules that are interpreted on demand or compiled in advance. Functions, methods and routines of the instructions are explained in more detail below.

Data 484 can be retrieved, stored or modified by processor 478 in accordance with instructions 482. For instance, although the subject matter described herein is not limited by any particular data structure, data 484 can be stored in computer registers, in a relational database as a table having many different fields and records, or eXtensible Markup Language (“XML”) documents. Data 484 can also be formatted in any computing device-readable format such as, but not limited to, binary values, ASCII or Unicode. Moreover, data 484 can comprise any information sufficient to identify the relevant information, such as numbers, descriptive text, proprietary codes, pointers, references to data stored in other memories such as at other network locations, or information that is used by a function to calculate the relevant data.

Processor 478 can be any conventional processor, such as a commercially available Central Processing Unit (“CPU”), that is specially programmed to operate the elect controller 370 as described herein. Alternatively, processor 478 can be a dedicated component such as an Application-Specific Integrated Circuit (“ASIC”) or other hardware-based processor.

Referring to FIG. 4A, indicators 472 indicate to the user whether controller 370 is powered on or off, whether light fixture 132 is turned on or off, and whether the photoelectric sensor is turned on or off, as discussed in further detail below. In addition, on/off input button 374 allows the user to turn controller 370 on and off. For example, on/off input button 374 may depress at a lower level when in an on position, and raise at a relatively higher level when in an off position. Manual/auto input button 376 may be configured to allow the user to either manually turn on and off light fixture 372 or allow light fixture 372 to be automatically controlled. For example, when manual/auto input button 376 is set to auto, controller 372 may automatically turn on and off light fixture 372 at certain times of the day and on certain days. Alternatively, a photoelectric sensor (not shown) may be implemented—which, in communication with processor 478, turns on and off light fixture 132 based on the detection of light. For example, the photoelectric sensor is configured to detect light; thus, when the photoelectric sensor detects light, a signal is sent to processor 478 to turn off light fixture 132. Conversely, when the photoelectric sensor no longer detects light, the sensor then sends a signal to processor 478 to turn on light fixture 132. The photoelectric sensor may be coupled with controller 370, positioned on a component of step ladder 102, or be a stand-alone component.

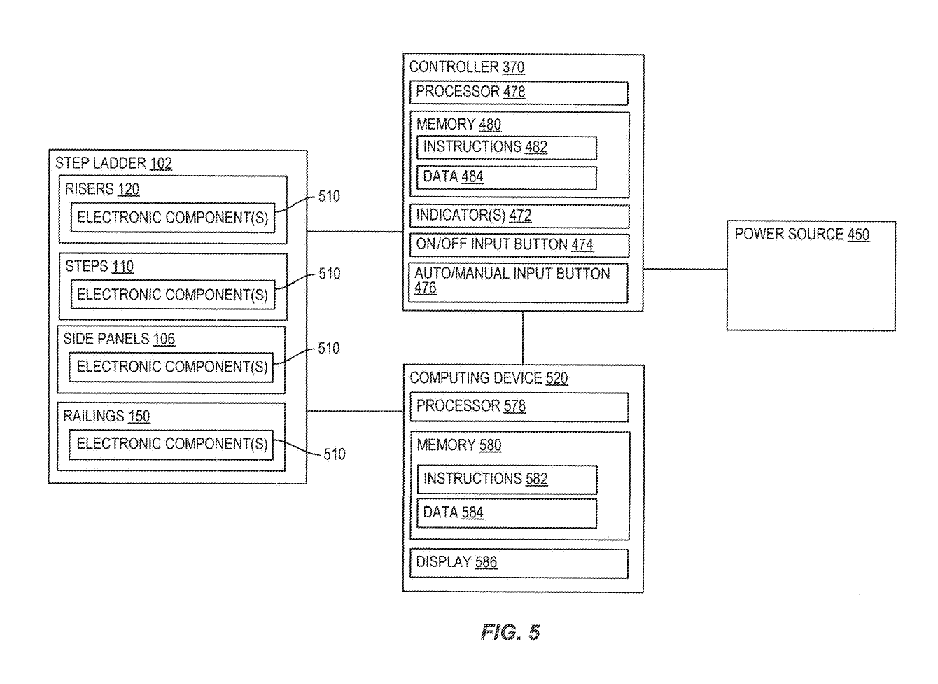

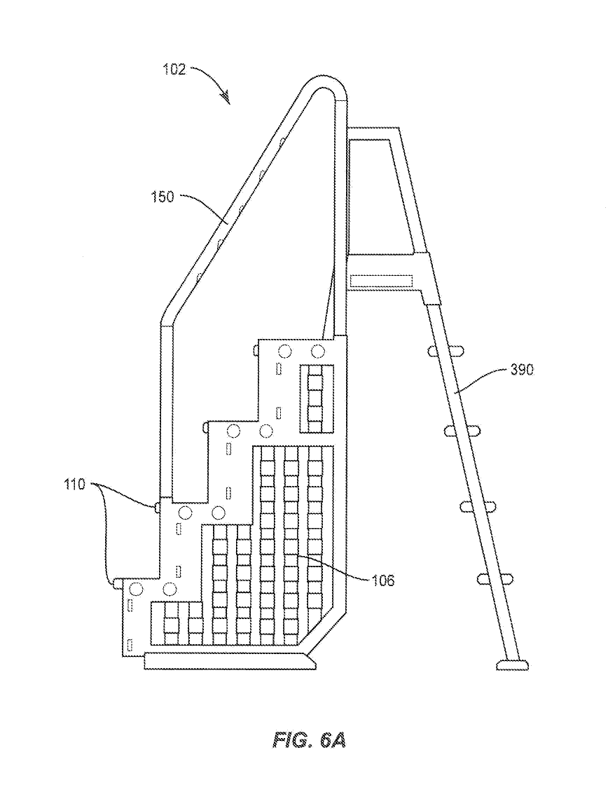

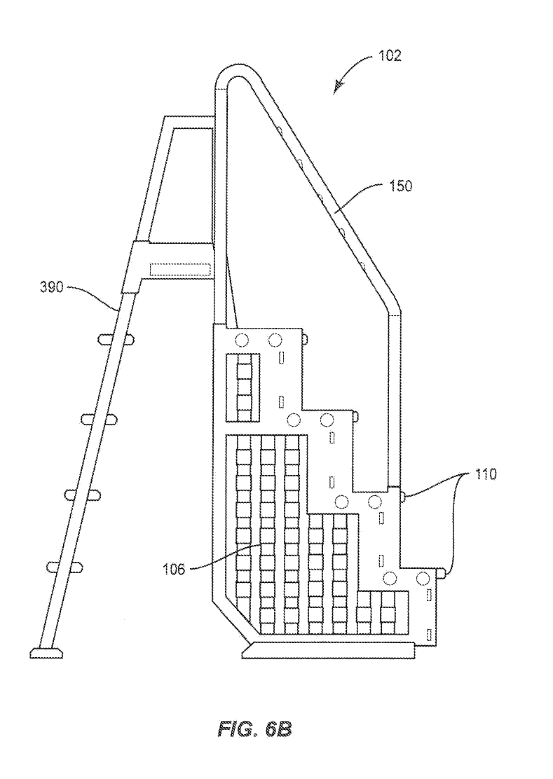

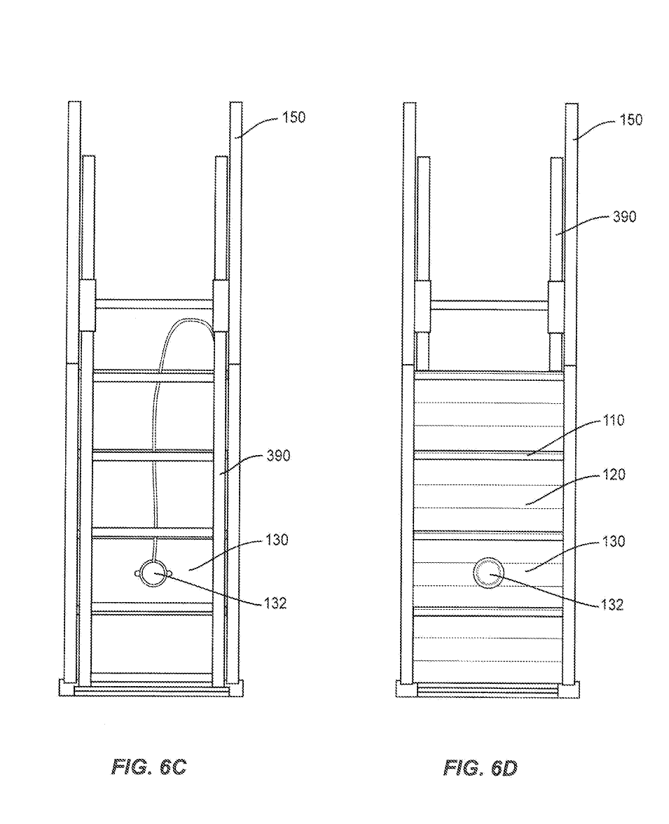

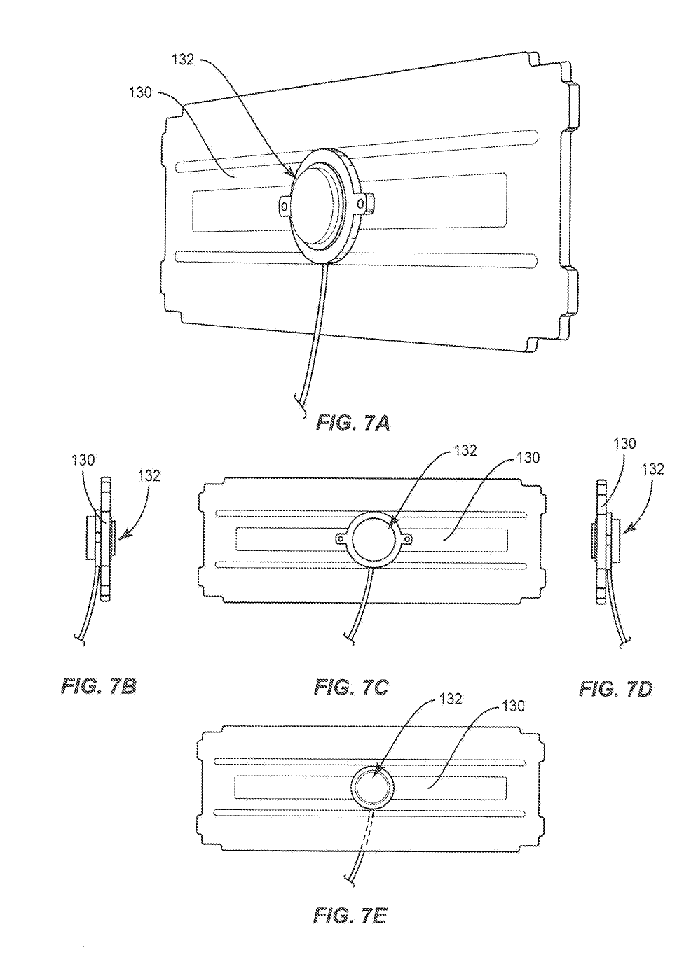

As an alternative embodiment, any type of electronic component may be implemented within riser 130, in addition to or as an alternative to light fixture 132. For example, a radio or speaker may be positioned within riser 130 or any of risers 120. In this regard and referring to FIG. 5, a user may be able to play music or any sound from riser 130 by connecting his or her computing device 520 either directly to riser 130 or indirectly to controller 370 first, which thereby transmits any data signals to the radio, speaker, or any electronic component of riser 130. Computing device 520 may be any type of computing device including a smart phone, tablet, personal computer, lap top, etc. In this regard, computing device 520 may connect to controller 370 or an electronic component of step ladder 102 wirelessly via Bluetooth, Wi-Fi, etc., or a direct wire, such as using USB, micro-USB, etc. In addition and as illustrated in FIG. 5, computing device 520 includes processor 578, memory 580 that includes instructions 582 and data 584, and a display 586. Computing device 520 may include other components typically associated with a computing device as well, including a transceiver such as blue tooth capabilities, input mechanism such as a touch screen or keyboard, etc.

As a further example, any type of one or more electronic components 510 may be positioned within any component of step ladder 102, including risers 120, steps 110, side panels 106 and railings 150. Similar to pre-assembled light riser 130 discussed above, any electronic components 510 may be sealed to make such electronic components waterproof. The electronic component 510 may include a light fixture, radio, speaker, blue tooth or other wireless capabilities. For example, one of the components of step ladder 102 may include an access point (AP) that communicates with a router, thereby providing Wi-Fi internet access to people near the pool or step ladder 102. In this regard and as illustrated in FIG. 5, computing device 520 may communicate with any one or more of electronic components 510 of step ladder 102. In this scenario, computing device 520 may use step ladder 102 as a means to access the Internet, or computing device 520 may control one or more of electronic components 510, such as playing music on a speaker that is positioned in ogre or more of the components of step ladder 102.

As a further example, a radio may be positioned within one or more of steps 110, a light fixture may be positioned in one or more of risers 120 and a speaker may be positioned in one or more of side panels 106. In this regard, any electronic component may be positioned in each of and any one of the components that make up step ladder 102. Even further, multiple different electronic components may be positioned in a single component of step ladder 102. For example, a single riser 120 may include a light fixture, speaker, and blue tooth capabilities. Alternatively, multiple risers, steps, railings, or side panels may include light fixtures, speakers, etc. It should be understood that any combination of electronic components may be implemented on step ladder 102, and the examples given herein are exemplary only.

In the scenario where multiple components of step ladder 102 include electronic components, each electronic component may include its own wire to connect to controller 370 or power source 450. Alternatively, a single component may connect to controller 370 and/or power source 450, and then that component may include one or more additional wires that connect to another component. For example, pre-assembled light riser 130 may connect to controller 370, and pre-assembled light riser 130 may include an additional wire to connect to railing 150, which thereby provides any power to electronic component 510 that is positioned within railing 150.

As discussed above with respect to pre-assembled light riser 130, any of the electronic components 510 positioned within any one of risers 120, steps 110, side panels 106 or railings 150, may be included with step ladder 102, or purchased separately which allows the user to replace one of the components of step ladder 102. For example, electronic component 510 may be already installed, in railing 150. Alternatively, if the user already has a railing that does not have any electronic component, the user may purchase a railing that includes a pro assembled electronic component 510, and thereby remove the railing without the electronic component with the railing that does have electronic component 510. In this regard and as discussed above with respect to the assembly of step ladder 102, any one of the components of step ladder 102 are removably attachable, such as via press-fit, friction fit, tab and notch, screw and bolt, etc. Therefore, the user may easily detach one of the components, such as railing 150, and then removably attach another railing that includes electronic component 510 to step ladder 102. It should be understood that any component can be replaced with an electronic component 510, such as side panels 106, railings 150 or steps 110. Thus, the astir is able to easily replace and assemble any electronic component into a component of step ladder 102.

Advantages or the step ladder in the present disclosure include the ability for users to have various electronic components when playing or hanging out by the pool. For example, step ladder 102 includes light fixture 132 to provide light at night, and in addition step ladder 102 can also be used to play music, relay Wi-Fi so users can access the internet when too far from his or her house, etc. In addition, the user can always add additional electronic capabilities to step ladder 102, since each component of step ladder 102 is removably attachable and thereby replaceable.

While the above description contains many specifies, these specifics should not be construed as limitations of the invention, but merely as exemplifications of preferred embodiments thereof. Those skilled in the art will envision many other embodiments within the scope and spirit of the invention as defined by the claims appended hereto.

1. A riser for steps, comprising:
a planar surface defining a hole therein; and
a light fixture positioned and secured within the hole,
wherein the riser is removably attachable to the steps.

2. The riser of claim 1, wherein the steps comprise:
a step removably attached to the riser;
a side panel removably attached to the step and the riser; and
a railing removably attached to the side panel.

3. The riser of step 2, farther comprising a second riser removably attached to the steps, wherein the second riser replaces a second riser of the steps by the second riser being detached from the steps and the second riser being attached to the steps in a same location that the second riser was attached.

4. The riser of claim 1, further comprising:
a controller connected to the light fixture, the controller configured to control settings associated with the light fixture.

5. The riser of claim 4, further comprising a power source for providing power to the controller and the light fixture.

6. The riser of claim 4, further comprising:
a photoelectric sensor connected to the controller, wherein the photoelectric sensor is configured to transmit a signal to the controller, the signal indicating whether or not the photoelectric sensor detects light,
wherein based on the signal received from the photoelectric sensor, the controller turns the light, fixture on or off.

7. The riser of claim 6, wherein the photoelectric sensor is positioned on one of the riser or the controller.

8. The riser of claim 1, wherein the light fixture is at least partially encapsulated and sealed on an outside portion of the light fixture, such that water cannot contact the light fixture.

9. The riser of claim 1, further comprising a second riser attached to the steps, wherein the second riser defines a hole with a second light fixture inserted and secured therein.

10. The riser of claim 9, further comprising:
a controller connected to the light fixture and the second light fixture, and the controller configured to control settings associated with the light fixture and the second light fixture; and
a power source for providing power to the controller and the light fixture and the second light fixture

11. The riser of claim 2, further comprising a removably attachable component that includes a pre-assembled electronic component, wherein the removably attachable component is configured to replace one of the step, the side panel, or the railing.

12. The riser of claim 11, wherein the pre-assembled electronic component includes one or more of a second light fixture, a radio, a speaker, and a wireless transmitter.

13. A step ladder, comprising:
a step;
a riser removably attached to the step,
wherein at least one of the step or the riser includes a pre-assembled electronic component.

14. The step ladder of claim 13, further comprising:
a controller comprising:
one or more processors; and
memory operatively coupled to the one or more processors,
wherein the controller is connected to the pre-assembled electronic component, and the controller is configured to control settings associated with the pre-assembled electronic component.

15. The step ladder of claim 14, wherein a computing device unassociated with the controller is configured to control settings associated with the pre-assembled electronic component.

16. The step ladder of claim 14, wherein:
the pre-assembled electronic component is a light fixture; and
the settings of the light fixture that the controller is configured to control include adjusting when the light fixture is turned on and off.

17. The step ladder of claim 16, wherein the light fixture is positioned within the step, and the step defines a cut-out where the light fixture is inserted and secured.

18. The step ladder of claim 17, further comprising:
a photoelectric sensor connected to the one or more processors, wherein the photoelectric sensor is configured to transmit a signal to the controller, the signal indicating whether or not the photoelectric sensor detects light,
wherein based on the signal received from the photoelectric sensor, the controller turns the light fixture on or off.

19. The step ladder of claim 13, further comprising:
a side panel removably attachable to one or more of the riser or the step;
a railing removably attachable to one or more of the step, the riser, or the side panel; and
an attachable component that includes a second pre-assembled electro component, wherein the attachable component is attachable to the step ladder to replace one of the step, riser, side panel, or tailing.

20. The step ladder of claim 19, wherein:
the second pre-assembled electronic component of the attachable component is a speaker, and the speaker is connected to the controller, and
the settings of the speaker that the controller is configured to control include powering the speaker on and off and adjusting a volume of the speaker.
